(19) United States
(12) Patent Application Publication
(10) Pub. No.: US 2026/0223939 A1
(43) Pub. Date: Aug. 6, 2026

(54) AEROSOL GENERATING DEVICE

(71) Applicant: SHENZHEN GEEKVAPE TECHNOLOGY CO., LTD., Shenzhen, Guangdong (CN)

(72) Inventors: Qiang CHEN, Shenzhen, Guangdong (CN); Gang LI, Shenzhen, Guangdong (CN)

(73) Assignee: SHENZHEN GEEKVAPE TECHNOLOGY CO., LTD., Shenzhen, Guangdong (CN)

(21) Appl. No.: 19/154,365

(22) PCT Filed: Aug. 20, 2024
(86) PCT No.: PCT/CN2024/113457

§ 371 Date: Aug. 6, 2025

(30) Foreign Application Priority Data
Aug. 25, 2023 (CN) 202322307021.5

(51) Int. Cl. A24F 40/485; A24F 7/00; A24F 40/46; A24F 40/50; A24F 40/60; H05B 1/02; H05B 3/02

(52) U.S. Cl. CPC A24F 40/485; A24F 7/00; A24F 40/46; A24F 40/50; A24F 40/60; H05B 1/0202; H05B 3/02

(57) ABSTRACT

The present disclosure provides an aerosol generating device. The aerosol generating device includes a housing assembly, at least two heating members, and an air regulating switch and a propulsion switch linked with each other. The housing assembly is provided with an airway, and the airway includes an air inlet. The at least two heating members are connected in parallel and provided in the housing assembly. The air regulating switch is movably connected to the housing assembly and is arranged at an end of the air inlet. The propulsion switch is electrically connected to the heating member. The air regulating switch is movable relative to the housing assembly to regulate an area of the air inlet, and drives the propulsion switch to regulate a number of the heating members in operation.

### RELATED APPLICATIONS

This application claims priority to a Chinese Patent Application entitled “Aerosol Generating Device” filed on Aug. 25, 2023 with application number 202322307021.5, which is incorporated herein by reference in its entirety.

### TECHNICAL FIELD

The present disclosure relates to the technical field of aerosol generating devices, and in particular, to an aerosol generating device.

### BACKGROUND

An aerosol generating device is a device in which an aerosol generating substrate is heated by heating members to generate aerosol for a user to vape.

At present, when the user adjusts an airway and heating members of the aerosol generating device, the operation is rather complicated and the user experience is poor.

### SUMMARY

It is an object of the present disclosure to propose an aerosol generating device to improve at least one of the above-mentioned technical problems. The present disclosure achieves the above object by the following technical proposals.

Embodiments of the present disclosure provide an aerosol generating device. The aerosol generating device includes a housing assembly, at least two heating members, and an air regulating switch and a propulsion switch linked with each other. The housing assembly is provided with an airway, and the airway includes an air inlet. The at least two heating members are connected in parallel and provided in the housing assembly. The air regulating switch is movably connected to the housing assembly and is arranged at an end of the air inlet. The propulsion switch is electrically connected to the heating members. The air regulating switch is movable relative to the housing assembly to regulate an area of the air inlet, and drives the propulsion switch to regulate a number of the heating members in operation.

In one of the embodiments, the air regulating switch slides relative to the housing assembly to regulate the area of the air inlet, and drives the propulsion switch to slide or rotate to regulate the number of the heating members in operation.

In one of the embodiments, the aerosol generating device includes a plurality of operation modes, and when the aerosol generating device is in different ones of the operation modes, the area of the air inlet is different, and the number of the heating members in operation is different.

In one of the embodiments, the housing assembly is provided with a plurality of limiting grooves, the plurality of limiting grooves are sequentially distributed in a sliding path of the air regulating switch, the air regulating switch includes a limiting protrusion, and the limiting protrusion is engaged with different limiting grooves when the aerosol generating device is in different ones of the operation modes; alternatively, the housing assembly is provided with a plurality of limiting protrusions, the plurality of limiting protrusions are sequentially distributed in the sliding path of the air regulating switch, the air regulating switch includes a limiting groove, and the limiting groove is engaged with different limiting protrusions when the aerosol generating device is in different ones of the operation modes.

In one of the embodiments, the air regulating switch includes a toggle member and a sliding member connected to each other, the toggle member is at least partially exposed out of the housing assembly, the sliding member is connected to the propulsion switch, the toggle member is configured to drive the sliding member to slide relative to the housing assembly to regulate an opening area of the air inlet, and drive the propulsion switch to slide to regulate the number of the heating members in operation.

In one of the embodiments, the sliding member is provided with one or more through holes, and the sliding member slides relative to the housing assembly to adjust a communication area between the through holes and the air inlet.

In one of the embodiments, a plurality of the through holes are provided, and the sliding member slides relative to the housing assembly to adjust a communication between different numbers of the through holes and the air inlet.

In one of the embodiments, the aerosol generating device further includes a sealing member, the sealing member abuts between the housing assembly and the sliding member, the airway passes through the sealing member, and the air inlet is provided on the sealing member.

In one of the embodiments, the housing assembly includes a housing body and a control board. The control board, the airway, the heating members, and the air regulating switch are all arranged on the housing body, the propulsion switch is arranged on the control board, and the heating members are electrically connected to the control board. The control board is provided with a positive connection part and a plurality of negative connection parts, each of the heating members includes a positive pin and a negative pin, the positive pin of each of the heating members is electrically connected to the positive connection part, and negative pins of different ones of the heating members are electrically connected to different ones of the negative connection parts. When one of the heating member is in an operation state, the positive pin of the same one of the heating members is conducted with the positive connection part, and the negative pin of the same one of the heating members is conducted with a corresponding one of the negative connection parts.

In one of the embodiments, the control board is provided with a negative connection part and a plurality of positive connection parts, each of the heating members includes a negative pin and a positive pin, the negative pin of each of the heating members is electrically connected to the negative connection part, and positive pins of different ones of the heating members are electrically connected to different ones of the positive connection parts. When one of the heating members is in an operation state, the negative pin of the same one of the heating members is conducted with the negative connection part, and the positive pin of the same one of the heating members is conducted with a corresponding one of the positive connection parts.

In one of the embodiments, the air regulating switch is configured to completely open the air inlet, when all the heating members are fully operated;
the air regulating switch is configured to partially block the air inlet, when some of the heating members are operated; and
the air regulating switch is configured to completely block the air inlet, when all the heating members stop working.

In the aerosol generating device provided in the embodiments of the present disclosure, at least two heating members are provided in parallel in the housing assembly, so that each heating member of the at least two heating members can operate independently. The housing assembly is provided with the airway, and the airway includes the an air inlet configured to communicate with an external environment so that external air can enter the airway. The air regulating switch is movably connected to the housing assembly and is arranged at an end of the air inlet, the propulsion switch is electrically connected to the heating member, the air regulating switch is linked with the propulsion switch, the air regulating switch is movable relative to the housing assembly to regulate the area of the air inlet and drives the propulsion switch to regulate the number of the heating members in operation. Therefore, when the air regulating switch moves relative to the housing assembly, the propulsion switch can be driven to move synchronously, allowing users to regulate the area of the air inlet and the number of the heating members in operation with one single adjustment of the air regulating switch, which helps reduce the likelihood of operational errors and is convenient to operate.

### DESCRIPTION OF DRAWINGS

In order to more clearly explain the technical proposals in the embodiments of the present disclosure or in the traditional technologies, the accompanying drawings that need to be used in the description of the embodiments or the traditional technologies will be briefly introduced below, and it is obvious that the accompanying drawings in the following description are only embodiments of the present disclosure, and other accompanying drawings can be obtained from the disclosed accompanying drawings without making creative work for those skilled in the art.

FIG. 1 is a schematic structural diagram of an aerosol generating device provided in embodiments of the present disclosure.

FIG. 2 is a schematic cross-sectional structural diagram of the aerosol generating device in FIG. 1 in an operation mode.

FIG. 3 is a partially schematic cross-sectional structural diagram of the aerosol generating device in FIG. 1.

FIG. 4 is a schematic structural diagram of an air regulating switch in FIG. 1.

FIG. 5 is an enlarged schematic diagram of a structure at V in FIG. 2.

FIG. 6 is a partially schematic cross-sectional structural diagram of the aerosol generating device in FIG. 2 in another operation mode.

FIG. 7 is a partially schematic cross-sectional structural diagram of the aerosol generating device in FIG. 2 in yet another operation mode.

FIG. 8 is a partially schematic cross-sectional structural diagram of the aerosol generating device in FIG. 2.

### REFERENCE NUMERALS

1, aerosol generating device; 10, housing assembly; 11, housing body; 13, control board; 15, vaporization pipeline; 20, heating member; 21, first heating member; 23, second heating member; 30, air regulating switch; 31, toggle member; 33, sliding member; 40 propulsion switch; 60, mouthpiece; 70, battery; 80, sealing member; 111, airway; 113, limiting groove; 131 mounting hole; 211, positive pin; 213, first negative pin; 231, second negative pin; 331, through hole; 333, limiting protrusion; 1111, air inlet; 3311, first hole; 3313, second hole; and 3315, third hole.

### DETAILED DESCRIPTION

The following will provide a clear and complete description of technical proposals in embodiments of the present disclosure in combination with the drawings. Apparently, the described embodiments are only some embodiments of the disclosure, not all of them. Based on the embodiments in the present disclosure, all other embodiments obtained by those skilled in the art without creative work fall within the scope of protection of the present disclosure.

Hereinafter, embodiments of the technical proposals of the present disclosure will be described in detail with reference to the accompanying drawings. The following embodiments are merely used to more clearly explain the technical proposals of the present disclosure, and therefore are merely examples, and cannot limit the scope of protection of the present disclosure.

Unless otherwise defined, all technical and scientific terms used herein have the same meaning as generally understood by those skilled in the technical field of the present disclosure. The terms used herein are intended solely to describe specific embodiments and are not intended to limit the present disclosure. The terms “comprise” and “include” as well as any variations thereof, in the specification, claims, and the description of the accompanying drawings of the present disclosure, are intended to encompass non-exclusive inclusion.

In the description of the embodiments of the present disclosure, the technical terms “first”, “second” and the like are only used to distinguish different objects, and cannot be understood to indicate or imply relative importance or implicitly indicate the number, specific order, or primary-secondary relationship of the indicated technical features. In the description of the embodiments of the present disclosure, the term “plurality of” means two or more unless otherwise explicitly and specifically defined.

The term “embodiments” means that a particular feature, structure or characteristic described in connection with the embodiments can be included in at least one embodiment of the present disclosure. This phrase in various places in the present disclosure are not necessarily all referring to the same embodiment, nor are separate or alternative embodiments mutually exclusive. It is explicitly and implicitly understood by a person skilled in the art that the embodiments described in this specification may be combined with other embodiments.

In the description of the embodiments of the present disclosure, the term “and/or” is only an association relationship describing an association object, and indicates that there may be three kinds of relationships, such as A and/or B, which may indicate that A exists alone, A and B exist simultaneously, and B exists alone. In addition, the character “/” in the papers generally indicates that the related objects before and after are in an “or” relationship.

In the description of the embodiments of the present disclosure, the term “plurality of” refers to two or more (including two). Similarly, “plurality of groups” refers to two or more groups (including two), and “plurality of pieces” refers to two or more pieces (including two).

In the description of the embodiments of the present disclosure, the technical terms “center”, “longitudinal”, “transverse”, “length”, “width”, “thickness”, “upper”, “lower”, “front”, “, “rear”, “left”, “right”, “vertical”, “horizontal”, “top”, “bottom”, “inside”, “outside”, “clockwise”, “counterclockwise”, “axial”, “radial”, “circumferential” etc. are based on the orientations or positional relationships shown in the drawings, which is only for the convenience of describing embodiments of the present disclosure and simplifying the description, and does not indicate or imply that the device or element referred to must have a specific orientation, be constructed and operated in a specific orientation, thus it cannot be construed as a limitation on the embodiments of the present disclosure.

In the description of the embodiments of the present disclosure, unless otherwise explicitly specified and limited, technical terms such as “mount”, “communicate”, “connect”, and “fix” are to be understood in a broad sense, for example, as a fixed connection, as a detachable connection, as an integrated connection, as an mechanical connection, an electrical connection, as an communication with each other, as an direct connection, as an indirect connection by means of an intermediate medium, as an internal communication of two elements, or as an interaction of two elements. The specific meaning of the above terms in the embodiments of the present disclosure may be understood by one of ordinary skill in the art depending on the specific circumstances.

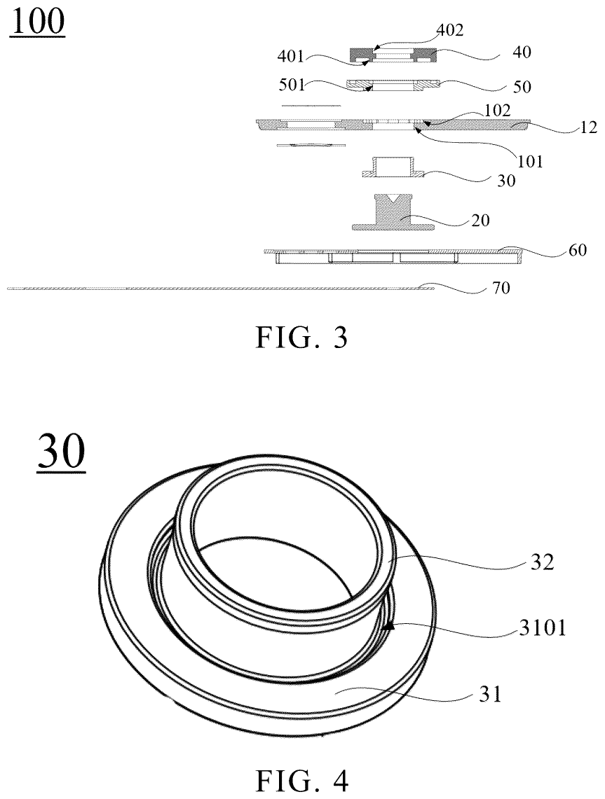

Referring to FIG. 1 to FIG. 3, embodiments of the present disclosure provide an aerosol generating device 1. The aerosol generating device 1 can be configured to heat an aerosol generating substrate, and the aerosol generating substrate generates an aerosol for a user to vape after being heated.

The aerosol generating device 1 includes a housing assembly 10, at least two heating members 20, an air regulating switch 30, and a propulsion switch 40.

The at least two heating members 20 are connected in parallel and provided in the housing assembly 10, so that each of the at least two heating members 20 can operate independently, or some of the heating members 20 can operate together, or all of the heating members 20 can operate together. The heating members 20 can be configured to heat the aerosol generating substrate when operating. For example, a vaporization pipeline 15 may be provided in the housing assembly 10, and the heating members may be arranged in the vaporization pipeline 15.

The at least two heating members 20 may refer to a plurality of heating members 20, for example, the at least two heating members 20 may refer to two heating members 20, three heating members 20, four heating members 20, or another number of heating members 20.

For example, the following will be described by taking that the at least two heating members 20 include two heating members 20 as an example. The two heating members 20 are respectively named as a first heating member 21 and a second heating member 23.

The housing assembly 10 is provided with an airway 111. The airway 111 includes an air inlet 1111. An air outlet of the airway 111 can communicate with the vaporization pipeline 15, and the air inlet 1111 can be configured to communicate with the external environment, so that external air can enter the airway 111, and then enter the vaporization pipeline 15 through the airway 111, so as to drive the aerosol in the vaporization pipeline 15 to flow and be vaped by the user.

The air regulating switch 30 is movably connected to the housing assembly 10 and is arranged at an end of the air inlet 1111. The propulsion switch 40 is electrically connected to the heating member 20. The air regulating switch 30 and the propulsion switch 40 are linked with each other, so that when the air regulating switch 30 moves relative to the housing assembly 10, the propulsion switch 40 can be driven to move together, so that the user can synchronously adjust the propulsion switch 40 by adjusting the air regulating switch 30 once, which helps to reduce the likelihood of operational errors, improves user experience, and is convenient to operate.

The air regulating switch 30 moves relative to the housing assembly 10 to regulate the area of the air inlet 1111, and drives the propulsion switch 40 to regulate the number of the heating members 20 in operation, so that when the user adjusts the air regulating switch 30, not only the area of the air inlet 1111 can be regulated to control a flow rate of the aerosol, but also the propulsion switch 40 can be synchronously driven to move to regulate the number of the heating members 20 in operation, thereby adjusting a generation speed of the aerosol by the aerosol generating device 1 to meet the diversified needs of the user, and being convenient to operate.

The fact that the air regulating switch 30 is movable relative to the housing assembly 10 to regulate the area of the air inlet 1111 may mean that the area of the air inlet 1111 is adjusted or regulated by blocking the air inlet 1111 or opening the air inlet 1111 when the air regulating switch 30 moves. The air regulating switch 30 may completely block the air inlet 1111, may partially block the air inlet 1111, or may completely open the air inlet 1111.

For example, the greater the number of the heating members 20 in operation, the greater an contact area between the heating members 20 and the aerosol generating substrate, resulting in faster aerosol generation. Consequently, the larger area of the air inlet 1111 is required to increase the flow rate of the aerosol. Therefore, the greater the number of the heating members 20 in operation, the greater the area of the air inlet 1111 of the airway 111. Specifically, when all the heating members 20 are completely operated, the air regulating switch 30 can fully open the air inlet 1111 to maximize the flow rate of the aerosol. When one or some of the heating members 20 is operated, the air regulating switch 30 may partially block the air inlet 1111. When all the heating members 20 stop working, the air regulating switch 30 can completely block the air inlet 1111, which helps to reduce impurities such as dust and liquid from entering the airway 111.

In one of the embodiments, the aerosol generating device 1 may include a mouthpiece 60. The mouthpiece 60 may be connected to the housing assembly 10 and communicate with the vaporization pipeline 15, that is, the airway 111, the vaporization pipeline 15, and the mouthpiece 60 are sequentially communicated. The user can vape the aerosol through the mouthpiece 60, driving the air of the external environment to enter the airway 111 from the air inlet 1111, and then enter the vaporization pipeline 15 through the airway 111, so as to drive the aerosol flow in the vaporization pipeline 15.

In one of the embodiments, the housing assembly 10 may include a housing body 11 and a control board 13. The control board 13, the airway 111, the heating members 20, and the air regulating switch 30 are all arranged on the housing body 11.

The propulsion switch 40 may be provided on the control board 13, the heating members 20 may be electrically connected to the control board 13, and the propulsion switch 40 may be electrically connected to the control board 13, so that the number of the heating members 20 in operation may be controlled by the control board 13 when the propulsion switch 40 moves.

In one of the embodiments, the mouthpiece 60 and the control board 13 may be arranged on opposite sides of the housing body 11 along a length direction, respectively, the control board 13 may be located in the housing body 11, and the propulsion switch 40 and the air regulating switch 30 are both located on a side of the control board 13 away from the mouthpiece 60.

In one of the embodiments, the housing assembly 10 may further include a battery 70. The battery 70 may be arranged in the housing body 11, and the battery 70 may be electrically connected to the control board 13 to provide electric energy for the control board 13, and the control board 13 transmits the electric energy to components such as the heating members 20.

In one of the embodiments, the control board 13 may be provided with a positive connection part and a plurality of negative connection parts. Each heating member 20 includes a positive pin 211 and a negative pin. The positive pin 211 of each heating member 20 is electrically connected to the positive connection part, and the negative pins of different heating members 20 are electrically connected to different negative connection parts. When the heating member 20 is in the operation state, the positive pin 211 of the same heating member 20 is conducted with the positive connection part, and the negative pin of the same heating member 20 is conducted with the negative connection part, so that the positive pin 211 is conducted with the negative pin of the heating member 20, and the heating member 20 converts the electric energy into heat energy to heat the aerosol generating substrate.

For example, the control board 13 may be provided with a negative connection part and a plurality of positive connection parts. Each heating member 20 includes a negative pin and a positive pin. The negative pin of each heating member 20 is electrically connected to the negative connection part, and the positive pins of different heating members 20 are electrically connected to different positive connection parts. When the heating member 20 is in the operation state, the negative pin of the same heating member 20 is conducted with the negative connection part, and the positive pin of the same heating member 20 is conducted with the positive connection part, so that the negative pin is conducted with the positive pin of the heating member 20, and the heating member 20 converts the electric energy into heat energy to heat the aerosol generating substrate.

In one of the embodiments, when the at least two heating members 20 are connected in parallel, all or part of the at least two heating members 20 may share the positive pin 211 or the negative pin, so as to reduce the difficulty of connection and also reduce the difficulty of layout of the control board 13.

For example, the first heating member 21 and the second heating member 23 share one positive pin 211, the first heating member 21 may further include a first negative pin 213, and the second heating member 23 may further include a second negative pin 231. Correspondingly, the control board 13 may be provided with a positive connection part, a first negative connection part, and a second negative connection part. The positive pin 211 shared by the first heating member 21 and the second heating member 23 may be connected to the positive connection part. The first negative pin 213 of the first heating member 21 may be connected to the first negative connection part, and the second negative pin 231 of the second heating member 23 may be connected to the second negative connection part. When the first heating member 21 is operated, both the positive pin 211 is conducted with the first negative pin 213 of the first heating member 21, and the first heating member 21 is energized. When the second heating member 23 is operated, both the positive pin 211 is conducted with the second negative pin 231 of the second heating member 23, and the second heating member 23 is energized.

In one of the embodiments, the aerosol generating device 1 may include a plurality of operation modes. When the aerosol generating device 1 is in different operation modes, the area of the air inlet 1111 is different, and the number of the heating members 20 in operation is different. When the aerosol generating device 1 is in different operation modes, the area of the air inlet 1111 and the number of the heating members 20 in operation can correspond to different operation modes, thereby reducing the likelihood of operational errors of the users.

For example, the plurality of operation modes may include a first operation mode, a second operation mode, and a third operation mode. In the first operation mode, the air regulating switch 30 may completely open the air inlet 1111, and the heating members 20 may all be in the operation state. In the second operation mode, the air regulating switch 30 may partially block the air inlet 1111, for example, the air regulating switch 30 may block half of the air inlet 1111, and one or a part of the plurality of heating members 20 may operate. In the third operation mode, the air regulating switch 30 may completely block the air inlet 1111, and all the heating members 20 may stop working.

For example, in the second operation mode, the air regulating switch 30 regulate a blocked area of the air inlet 1111, and correspondingly, the number of the heating members 20 in operation may also be regulated. Therefore, the aerosol generating device 1 may include a plurality of second operation modes, and the plurality of second operation modes may include a first sub-mode, a second sub-mode, a third sub-mode, etc.

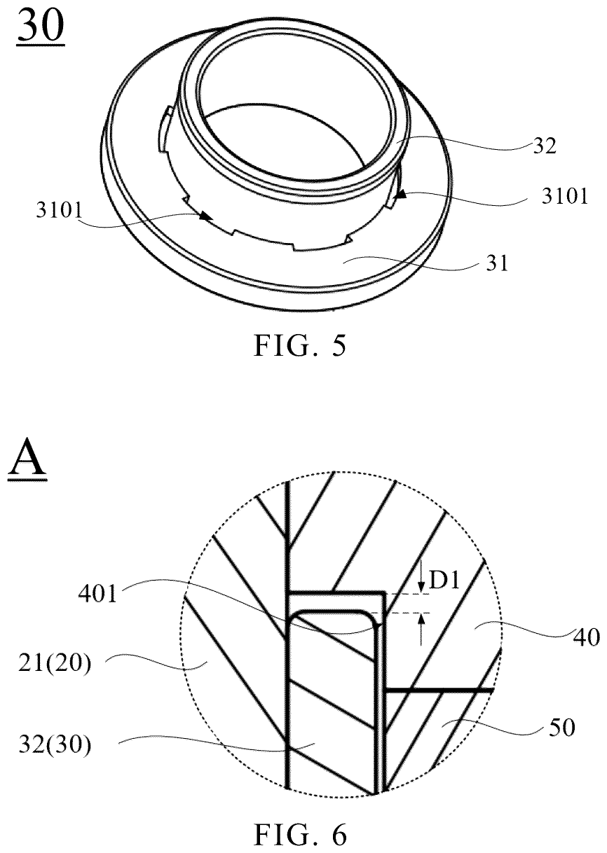

In one of the embodiments, the air regulating switch 30 can slide relative to the housing assembly 10 to regulate the area of the air inlet 1111, and drive the propulsion switch 40 to slide to regulate the number of the heating members 20 in operation. By sliding the air regulating switch 30, the user can synchronously slide the propulsion switch 40 to regulate the number of the heating members 20 in operation while regulating the area of the air inlet 1111. The structure is relatively simple and easy to implement. For example, in FIG. 5, the air regulating switch 30 may slide left and right to drive the propulsion switch 40 to slide left and right.

In one of the embodiments, the housing body 11 may be provided with a sliding groove, and the air regulating switch 30 may be slidably arranged in the sliding groove.

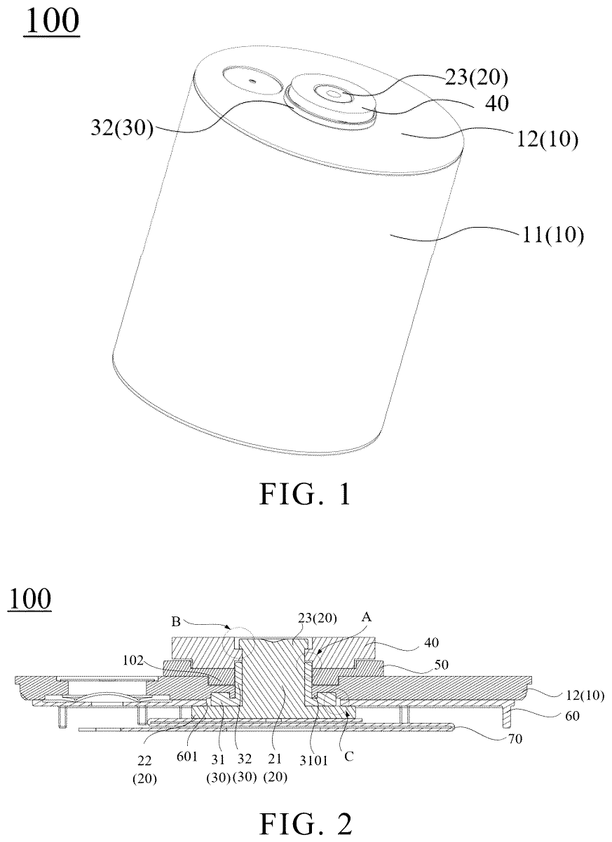

Referring to FIG. 2, FIG. 4, and FIG. 8, in one of the embodiments, the air regulating switch 30 may include a toggle member 31 and a sliding member 33 connected to each other. The toggle member 31 is at least partially exposed out of the housing assembly 10, and the sliding member 33 is connected to the propulsion switch 40. The toggle member 31 is configured to drive the sliding member 33 to slide relative to the housing assembly 10 to regulate an opening area of the air inlet 1111, and to drive the propulsion switch 40 to slide to regulate the number of the heating members 20 in operation. This allows the user to toggle the toggle member 31 to drive the sliding member 33 to slide, thus opening or blocking the air inlet 1111. As the sliding member 33 slides, it can also drive the propulsion switch 40 to slide, thereby controlling the number of the heating members 20 in operation. In this way, the user can toggle the toggle member 31 once to simultaneously regulate the area of the air inlet 1111 and the number of the heating members 20 in operation.

In one of the embodiments, the housing assembly 10 may be provided with a plurality of limiting grooves 113. The plurality of limiting grooves 113 are sequentially distributed in a sliding path of the air regulating switch 30. The air regulating switch 30 includes a limiting protrusion 333. When the aerosol generating device 1 is in different operation modes, the limiting protrusion 333 is engaged with different limiting grooves 113, allowing the user to adjust the operation mode of the aerosol generating device 1 more accurately, reducing the likelihood of operational errors, and enhancing the user experience.

For example, the limiting protrusion 333 may be provided on opposite sides of the sliding member 33 along a sliding direction, both sides of the sliding member 33 are slidably connected to the housing body 11, and the plurality of limiting grooves 113 are provided on side surfaces of the housing body 11 connected to the sliding member 33. During the toggle member 31 drives the sliding member 33 to slide, the limiting protrusion 333 on both sides of the sliding member 33 can be snapped into the limiting grooves 113. When the aerosol generating device 1 is in different operation modes, the limiting protrusion 333 can be snapped into the corresponding limiting groove 113.

For example, the positions of the limiting groove 113 and the limiting protrusion 333 may also be switched with each other. Specifically, the housing assembly 10 may be provided with a plurality of limiting protrusions 333, and the plurality of limiting protrusions 333 are sequentially distributed in the sliding path of the air regulating switch 30, and the air regulating switch 30 may include a limiting groove 113, and the limiting groove 113 is engaged with different limiting protrusions 333 when the aerosol generating device 1 is in different operation modes.

Referring to FIG. 4 to FIG. 5, in one of the embodiments, the sliding member 33 may be provided with one or more through holes 331. The sliding member 33 slides relative to the housing assembly 10 to regulate a communication area between the through holes 331 and the air inlet 1111. The through hole 331 may be configured to communicate the air inlet 1111 and the external environment. When the sliding member 33 slides, a position of the through hole 331 relative to the air inlet 1111 may be adjusted, enabling the through hole 331 to be in full communication with the air inlet 1111, partial communication with the air inlet 1111, or the air inlet 1111 to be completely blocked by the sliding member 33, thereby adjusting the operation mode of the aerosol generating device 1.

For example, the through hole 331 may be communicated with the sliding groove on the housing body 11, and the sliding groove may be communicated with the external environment. When the through hole 331 and the air inlet 1111 are communicated, the external air may sequentially pass through the sliding groove and the through hole 331, and then enter the airway 111 through the air inlet 1111.

Referring to FIG. 2, FIG. 4, and FIG. 5, in one of the embodiments, a plurality of the through holes 331 may be provided. The sliding member 33 slides relative to the housing assembly 10 to adjust the communication between different number of the through holes 331 and the air inlet 1111, thereby regulating the number of through holes 331 communicated with the air inlet 1111. This allows control over the number of the through holes 331 that are communicated with the air inlet 1111. By varying the number of the through holes 331 communicated with the air inlet 1111, the area of the air inlet 1111 can be regulated, enabling more precise control over the opening area of the air inlet 1111. This, in turn, allows for more stable control of the flow of the aerosol, thereby enhancing the user experience.

Here, the term “plurality of” may refer to two or more, that is, the sliding member 33 may be provided with two through holes 331, three through holes 331, four through holes 331, or another number of through holes 331. For convenience of description, the following will explain that the sliding member 33 is provided with three through holes 331 as an example, and the three through holes 331 are named as a first hole 3311, a second hole 3313, and a third hole 3315, respectively.

For example, the number of the through holes 331 communicated with the air inlet 1111 is different in different operation modes.

In one of the embodiments, the plurality of through holes 331 may be arranged as desired.

In one of the embodiments, diameters of the plurality of through holes 331 may or may not be the same.

Referring to FIG. 4 to FIG. 5, in one of the embodiments, the aerosol generating device 1 may further include a sealing member 80. The sealing member 80 may abut between the housing assembly 10 and the sliding member 33. The airway 111 passes through the sealing member 80, and the air inlet 1111 may be provided on the sealing member 80. The sliding member 33 slides relative to the housing assembly 10 to adjust the communication between different numbers of through holes 331 and the air inlet 1111, thereby improving the issue of air leakage at the air inlet 1111.

For example, the sealing member 80 may be arranged in the housing body 11, a side of the sealing member 80 away from the mouthpiece 60 may be provided with a sealing boss, the airway penetrates the sealing boss, and the air inlet 1111 may be provided on the sealing boss. The control board 13 may be provided with a mounting hole 131, and the sealing boss may be inserted in the mounting hole 131 and abut against the sliding member 33 to seal the air inlet 1111, which helps to avoid the malfunction of the air regulating switch 30 due to the air leakage at the air inlet 1111.

For example, under the condition that the aerosol generating device 1 is not provided with the sealing member 80, the air regulating switch 30 may be fitted to the control board 13, the mounting hole 131 may communicate the airway 111 with the external environment, and the air inlet 1111 may be provided in the mounting hole 131. When the sliding member 33 slides relative to the housing assembly 10, an area of the mounting hole 131 may be adjusted, or a communication area between the through holes 331 and the mounting hole 131 may be adjusted, or different numbers of the through holes 331 communicated with the mounting hole 131 may be adjusted.

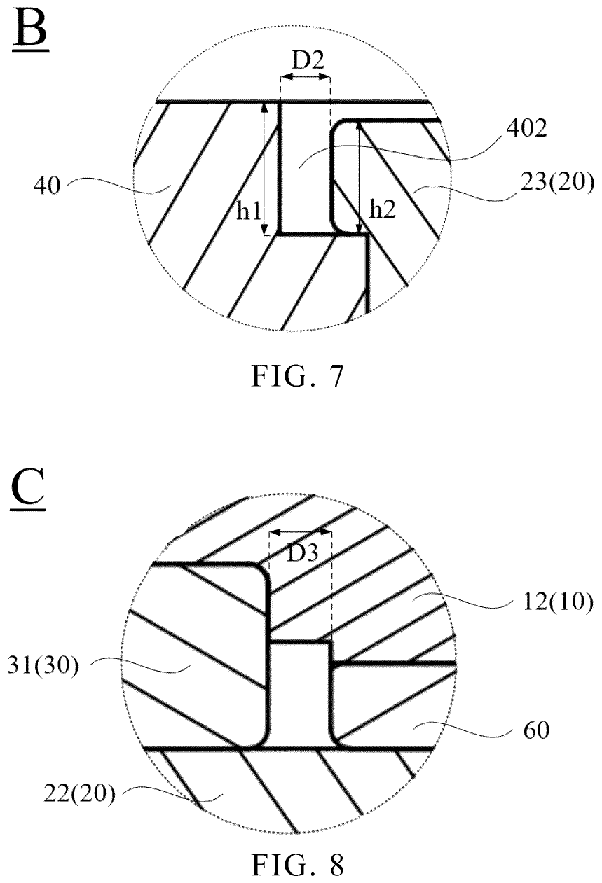

For example, in the first operation mode, as shown in FIG. 6, the first hole 3311, the second hole 3313, and the third hole 3315 may each be communicated with the external environment and the air inlet 1111, air in the external environment may enter the air inlet 1111 through the first hole 3311, the second hole 3313, and the third hole 3315, and the first heating member 21 and the second heating member 23 may each be in the operation state. In the second operation mode, as shown in FIG. 5, both the first hole 3311 and the second hole 3313 can be communicated with the external environment and the air inlet 1111, and the air of the external environment can enter the air inlet 1111 through the first hole 3311 and the second hole 3313, and one of the first heating member 21 and the second heating member 23 is in the operation state. In the third operation mode, as shown in FIG. 7, the first hole 3311, the second hole 3313, and the third hole 3315 are all in a misalignment with the air inlet 1111, the sliding member 33 blocks the air inlet 1111, and the first heating member 21 and the second heating member 23 are both in a non-operational state.

In one of the embodiments, the sealing member 80 may be made of an elastic material to enhance the sealing effect, for example, the sealing member 80 may be made of a silicone seal.

For example, the air regulating switch 30 may regulate the area of the air inlet 1111 by sliding, and the air regulating switch 30 may also regulate the area of the air inlet 1111 by rotating.

For example, the air regulating switch 30 rotates relative to the housing assembly 10 to regulate the area of the air inlet 1111, and drives the propulsion switch 40 to slide to regulate the number of the heating members 20 in operation. The user can synchronously slide the propulsion switch 40 by rotating the air regulating switch 30, and then regulate the number of the heating members 20 in operation while adjusting the area of the air inlet 1111, so that the air regulating switch 30 can have a variety of structures to meet different needs of the user.

In the aerosol generating device 1 provided in the embodiments of the present disclosure, the at least two heating members 20 are connected in parallel and provided in the housing assembly 10, so that each heating member 20 of the at least two heating members 20 can work independently. The housing assembly 10 is provided with the airway 111, and the airway 111 includes the air inlet 1111 configured to communicate with the external environment, so that external air can enter the airway 111. The air regulating switch is movably connected to the housing assembly 10 and is arranged at an end of the air inlet 1111, the propulsion switch 40 is electrically connected to the heating members 20, the air regulating switch 30 is linked with the propulsion switch 40, the air regulating switch 30 is movable relative to the housing assembly 10 to regulate the area of the air inlet 1111 and drives the propulsion switch 40 to regulate the number of the heating members 20 in operation. Therefore, when the air regulating switch 30 moves relative to the housing assembly 10, the propulsion switch 40 can be driven to move synchronously, allowing users to regulate the area of the air inlet 1111 and the number of the heating members 20 in operation with one single adjustment of the air regulating switch 30, which helps reduce the likelihood of operational errors and is convenient to operate.

The technical features of the above-described embodiments can be arbitrarily combined, and all possible combinations of the technical features of the above-described embodiments have not been described in order to make the description concise, but as long as there is no contradiction between the combinations of the technical features, they should be considered to be within the scope of the present specification.

The above-described embodiments merely express a few embodiments of the present disclosure, and the description thereof is relatively specific and detailed, but should not be construed as limiting the scope of the patent application. It should be noted that a person of ordinary skill in the art may make various changes and improvements without departing from the ideas of the present disclosure, which, shall all fall within the protection scope of the present disclosure. Therefore, the protection scope of the present disclosure is subject to the protection scope of the appended claims.

What is claimed is:

1. An aerosol generating device, comprising:
a housing assembly provided with an airway, and the airway comprising an air inlet;
at least two heating members connected in parallel and provided in the housing assembly; and
an air regulating switch and a propulsion switch linked with each other, wherein the air regulating switch is movably connected to the housing assembly and is arranged at an end of the air inlet, the propulsion switch is electrically connected to the heating members, the air regulating switch is movable relative to the housing assembly to regulate an area of the air inlet and drives the propulsion switch to regulate a number of the heating members in operation.

2. The aerosol generating device according to claim 1, wherein the air regulating switch slides or rotates relative to the housing assembly to regulate the area of the air inlet, and drives the propulsion switch to slide to regulate the number of the heating members in operation.

3. The aerosol generating device according to claim 2, wherein the aerosol generating device comprises a plurality of operation modes, and when the aerosol generating device is in different ones of the operation modes, the area of the air inlet is different, and the number of the heating members in operation is different.

4. The aerosol generating device according to claim 3, wherein the housing assembly is provided with a plurality of limiting grooves, the plurality of limiting grooves are sequentially distributed in a sliding path of the air regulating switch, the air regulating switch comprises a limiting protrusion, and when the aerosol generating device is in different ones of the operation modes, the limiting protrusion is engaged with different ones of the limiting grooves; or
the housing assembly is provided with a plurality of limiting protrusions, the plurality of limiting protrusions are sequentially distributed in the sliding path of the air regulating switch, the air regulating switch comprises a limiting groove, and when the aerosol generating device is in different ones of the operation modes, the limiting groove is engaged with different ones of the limiting protrusions.

5. The aerosol generating device according to claim 2, wherein the air regulating switch comprises a toggle member and a sliding member connected to each other, the toggle member is at least partially exposed out of the housing assembly, the sliding member is connected to the propulsion switch, and the toggle member is configured to drive the sliding member to slide relative to the housing assembly to regulate the area of the air inlet and drive the propulsion switch to slide to regulate the number of the heating members in operation.

6. The aerosol generating device according to claim 5, wherein the sliding member is provided with one or more through holes, and the sliding member slides relative to the housing assembly to adjust a communication area between the through holes and the air inlet.

7. The aerosol generating device according to claim 6, wherein a plurality of the through holes are provided, and the sliding member slides relative to the housing assembly to adjust a communication between different numbers of the through holes and the air inlet.

8. The aerosol generating device according to claim 5, wherein the aerosol generating device further comprises a sealing member, the sealing member abuts between the housing assembly and the sliding member, the airway passes through the sealing member, and the air inlet is provided on the sealing member.

9. The aerosol generating device according to claim 1, wherein the housing assembly comprises a housing body and a control board, the control board, the airway, the heating members, and the air regulating switch are all arranged on the housing body, the propulsion switch is arranged on the control board, and the heating members are electrically connected to the control board; and
the control board is provided with a positive connection part and a plurality of negative connection parts, each of the heating members comprises a positive pin and a negative pin, the positive pin of each of the heating members is electrically connected to the positive connection part, and negative pins of different ones of the heating members are electrically connected to different ones of the negative connection parts; when one of the heating members is in an operation state, the positive pin of the same one of the heating members is conducted with the positive connection part, and the negative pin of the same one of the heating members is conducted with a corresponding one of the negative connection parts; or
the control board is provided with a negative connection part and a plurality of positive connection parts, each of the heating members comprises a negative pin and a positive pin, the negative pin of each of the heating members is electrically connected to the negative connection part, and positive pins of different ones of the heating members are electrically connected to different ones of the positive connection parts; when one of the heating members is in an operation state, the negative pin of the same one of the heating members is conducted with the negative connection part of the same heating member, and the positive pin of the same one of the heating members is conducted with a corresponding one of the positive connection parts.

10. The aerosol generating device according to claim 1, wherein
the air regulating switch is configured to completely open the air inlet, when all the heating members are fully operated;
the air regulating switch is configured to partially block the air inlet, when some of the heating members are operated; and
the air regulating switch is configured to completely block the air inlet, when all the heating members stop working.

11. The aerosol generating device according to claim 1, wherein a vaporization pipeline is provided in the housing assembly, the vaporization pipeline is communicated with the airway, and the heating members are arranged in the vaporization pipeline.

12. The aerosol generating device according to claim 11, further comprising a mouthpiece, wherein the mouthpiece is connected to the housing assembly, and the airway, the vaporization pipeline, and the mouthpiece are sequentially communicated.

13. The aerosol generating device according to claim 12, wherein the housing assembly comprises a housing body and a control board; the control board, the airway, the heating members, and the air regulating switch are all arranged on the housing body, the propulsion switch is arranged on the control board, the heating members are electrically connected to the control board, and the control board is configured to control the number of the heating members in operation when the propulsion switch moves;
the mouthpiece and the control board are arranged on opposite sides of the housing body along a length direction, respectively, the control board is located in the housing body, and the propulsion switch and the air regulating switch are both located on a side of the control board away from the mouthpiece.

14. The aerosol generating device according to claim 13, wherein the housing assembly further comprises a battery, the battery is arranged in the housing body and is electrically connected to the control board to provide electric energy for the control board.

15. The aerosol generating device according to claim 13, wherein the control board is provided with a positive connection part and a plurality of negative connection parts, each of the heating members comprises a positive pin and a negative pin, the positive pin of each of the heating members is electrically connected to the positive connection part, and negative pins of different ones of the heating members are electrically connected to different ones of the negative connection parts; when one of the heating members is in an operation state, the positive pin of the same one of the heating members and the positive connection part are conductive, and the negative pin of the same one of the heating members and a corresponding one of the negative connection parts are conductive.

16. The aerosol generating device according to claim 13, wherein the control board is provided with a negative connection part and a plurality of positive connection parts, each of the heating members comprises a negative pin and a positive pin, the negative pin of each of the heating members is electrically connected to the negative connection part, and positive pins of different ones of the heating members are electrically connected to different ones of the positive connection parts; when one of the heating members is in an operation state, the negative pin of the same one of the heating members and the negative connection part of the same heating member are conductive, and the positive pin of the same one of the heating members and a corresponding one of the positive connection parts are conductive.

17. The aerosol generating device according to claim 1, wherein when the at least two heating members are connected in parallel, all or part of the at least two heating members share one positive pin or one negative pin.
